(19) United States
(12) Patent Application Publication
(10) Pub. No.: US 2009/0277899 A1
(43) Pub. Date: Nov. 12, 2009

(54) Microwave energy interactive tray and wrap

(76) Inventor: Lorin R. Cole, Larsen, WI (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/387,729

(22) Filed: May 7, 2009

Related U.S. Application Data
(60) Provisional application No. 61/051,711, filed on May 9, 2008.

(51) Int. Cl. H05B 6/80

(52) U.S. Cl. 219/730

(57) ABSTRACT

A microwave heating apparatus for a food item comprises a panel for receiving the food item, a first susceptor joined to a side of the panel facing the food item, and a microwave energy interactive wrap comprising a second susceptor. The microwave energy interactive wrap may include a first portion attached to a side of the panel opposite the food item, the first portion being at least partially superposed with the first susceptor, a second portion adapted to overlie the food item on the panel, and a third portion adapted to be positioned beneath the first portion.

### CROSS-REFERENCE TO RELATED APPLICATION

This application claims the benefit of U.S. Provisional Application No. 61/051,711, filed May 9, 2008, which is incorporated by reference herein in its entirety.

### TECHNICAL FIELD

This disclosure relates to various materials, packages, constructs, and systems for heating or cooking one or more microwavable food items. In particular, this disclosure relates to various materials, packages, constructs, and systems for heating, browning, and/or crisping one or more food items in a microwave oven.

### BACKGROUND

Microwave ovens provide a convenient means for heating a variety of food items, including breaded food items, potato-based food items, and dough-based food items, such as chicken strips, French fries, pizza bites, and stuffed dough products. However, microwave ovens tend to cook such items unevenly and are unable to achieve the desired balance of thorough heating and a browned, crisp outer surface. As such, there is a continuing need for improved materials and packages that provide the desired degree of heating, browning, and/or crisping of food items in a microwave oven.

### SUMMARY

This disclosure is directed generally to various constructs, apparatuses, or packages (collectively referred to as “packages”) for preparing a food item in a microwave oven. Any of such packages may include a first component for receiving the food item and a second component for enwrapping the first component. In some embodiments, the first component is a dimensionally stable panel, card, tray, or other structure suitable for supporting the food item. The first component may be formed from paper, paperboard, a polymer, or any other suitable material. The second component may be a flexible material or wrap suitable for enwrapping the food item and the first component.

The first component and the second component may each include at least one microwave energy interactive element for altering the effect of microwave energy on the food item. In one particular example, the first component and the second component each include a susceptor that converts at least a portion of the impinging microwave energy into thermal energy, which then can heat, brown, and/or crisp the food item. The susceptors may be configured so that the bottom of the food item is adjacent to a susceptor on the first component and the top of the food item is adjacent to a susceptor on the second component, thereby providing simultaneous heating, browning, and/or crisping of multiple surfaces of the food item.

If desired, the first component and the second component may be joined to one another. In some embodiments, the second component may be joined to a side of the first component opposite the food item, such that the food item overlies the susceptor of the first component and part of the susceptor of second component.

During use in some embodiments, the second component may be secured in position by tucking an end of the second component beneath the first component, such that the weight of the food item and the first component serve to hold the second component in an enwrapped condition around the food item and the first component. Depending on the dimensions of the second component, the second component may provide additional heating to the bottom of the food item.

Other aspects, features, and advantages of the present invention will become apparent from the following description and accompanying figures.

### BRIEF DESCRIPTION OF THE DRAWINGS

The description refers to the accompanying schematic drawings in which like reference characters refer to like parts throughout the several views, and in which:

FIG. 1A is a schematic perspective view of an exemplary microwave energy interactive heating package including an exemplary microwave energy interactive wrap, in an open configuration;

FIG. 1B is a schematic cross-sectional view of the exemplary microwave energy interactive wrap of FIG. 1A taken along a line 1B-1B;

FIG. 1C is a schematic bottom plan view of the package of FIG. 1A;

FIG. 1D is a schematic perspective view of the exemplary package of FIG. 1A, in a closed configuration;

FIG. 1E is a schematic cross-sectional view of the exemplary package of FIG. 1D, taken along a line 1E-1E;

FIG. 1F is a schematic cross-sectional view of the exemplary package of FIGS. 1D and 1E with a differently dimensioned microwave energy interactive wrap;

FIG. 2A is a schematic cross-sectional view of a portion of an exemplary microwave energy interactive insulating material that may be used as a microwave energy interactive wrap in accordance with the disclosure;

FIG. 2B is a schematic perspective view of the insulating material of FIG. 2A, in the form of a cut sheet;

FIG. 2C is a schematic perspective view of the sheet of FIG. 2B, after sufficient exposure to microwave energy;

FIG. 2D is a schematic perspective view of another exemplary microwave energy interactive heating package including the exemplary microwave energy interactive insulating material of FIGS. 2A-2C as a microwave energy interactive wrap;

FIG. 2E is a schematic cross-sectional view of the exemplary package of FIG. 2D, taken along a line 2E-2E;

FIG. 2F is a schematic cross-sectional view of the exemplary package of FIGS. 2D and 2E with a differently dimensioned microwave energy interactive wrap;

FIG. 3 is a schematic cross-sectional view of another exemplary microwave energy interactive insulating material that may be used as a microwave energy interactive wrap in accordance with the disclosure;

FIG. 4 is a schematic cross-sectional view of yet another exemplary microwave energy interactive insulating material that may be used as a microwave energy interactive wrap in accordance with the disclosure; and

FIG. 5 is a schematic cross-sectional view of still another exemplary microwave energy interactive insulating material that may be used as a microwave energy interactive wrap in accordance with the disclosure.

### DESCRIPTION

Various aspects of the disclosure may be illustrated by referring to the figures. For purposes of simplicity, like numerals may be used to describe like features. It will be understood that where a plurality of similar features are depicted, not all of such features are necessarily labeled on each figure. While various exemplary embodiments are shown and described in detail herein, it also will be understood that any of the features may be used in any combination, and that such combinations are contemplated hereby.

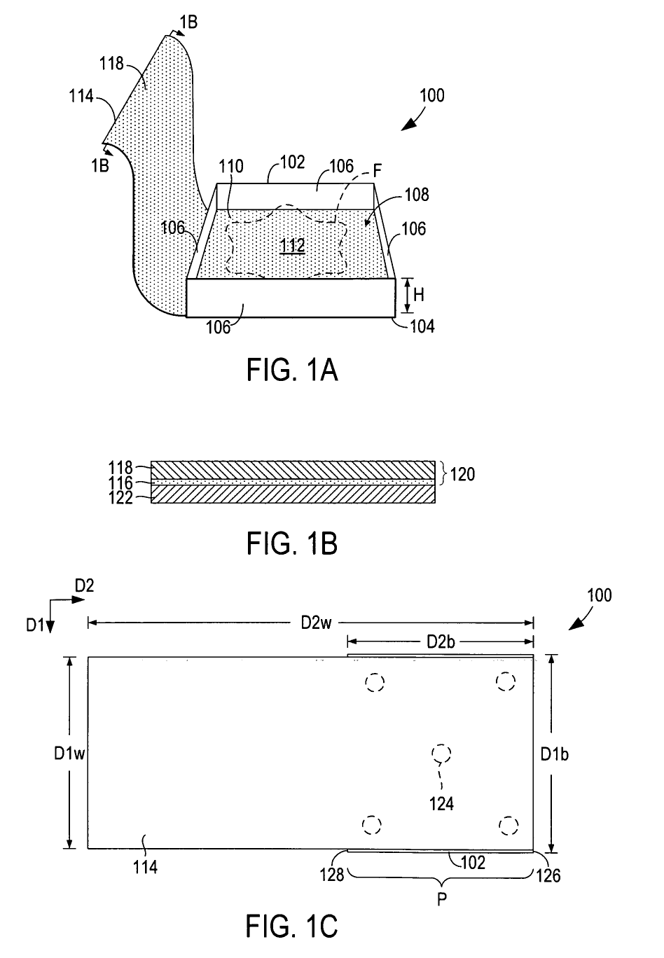

FIG. 1A schematically illustrates an exemplary apparatus, construct, or package 100 that may be used to heat, brown, and/or crisp a food item in a microwave oven. By way of example, and not limitation, the food item (or items) may be a dough-based food item (e.g. a pastry pocket sandwich), a breaded food item (e.g., chicken nuggets), French fries, or any other suitable food item having at least one surface that is desirably heated, browned, and/or crisped.

In this embodiment, the package 100 includes a tray 102 comprising a base or base panel 104 and a plurality of substantially upstanding side panels or walls 106 that define a cavity 108 for receiving a food item (or items). However, in other embodiments (not shown), the tray 102 may be replaced with a panel or card with fewer or no side panels or walls.

A microwave energy interactive element 110 (shown schematically with stippling in FIG. 1A) overlies and is joined to at least a portion of the interior side of the tray 102, in this example, to the interior side (e.g., top or first side) of the base 104 facing the cavity 108. In one example, the microwave energy interactive element 110 comprises a susceptor, i.e., a thin layer of microwave energy interactive material (generally less than about 100 angstroms (about 0.01 micrometers) in thickness, for example, from about 60 to about 100 angstroms (about 0.006 to about 0.01 micrometers)) in thickness, and having an optical density of from about 0.15 to about 0.35, for example, about 0.21 to about 0.28) that tends to absorb at least a portion of impinging microwave energy and convert it to thermal energy (i.e., heat) at the interface with the food item. Susceptor elements often are used to promote browning and/or crisping of the surface of a food item. The susceptor may be supported on a microwave energy transparent substrate, for example, a polymer film, thereby collectively forming a “susceptor film”. The susceptor film typically is positioned in the package 100 such that the polymer film at least partially defines an interior surface 112 of the tray 102 for contacting the food item.

The package 100 also includes a substantially flexible microwave energy interactive wrap or covering 114 dimensioned to enfold the tray 102. In one example shown in FIG. 1B, the wrap 114 comprises a susceptor 116 (shown schematically with stippling in FIGS. 1A and 1B) supported on a polymer film 118 to define a susceptor film 120. The susceptor film 120 may be joined to a microwave energy transparent support 122, for example, paper, paperboard, or polymer film using an adhesive (not shown) or otherwise, such that the susceptor 116 is disposed between the polymer film 118 and the support 122.

If desired, the wrap 114 may be joined to the tray 102, for example, to the exterior side (e.g., the bottom or second side) of the base 104 (i.e., the bottom of the tray 102) using a plurality of adhesive circles or “dots” 124, as shown schematically with dashed lines in FIG. 1C, or using any other adhesive pattern or configuration and/or any other mechanical or thermal fastening technique. Alternatively, the wrap 114 may be provided as a separate component from the tray 102.

As shown in FIG. 1C, the base 104 of the tray 102 and the microwave energy interactive wrap 114 each generally have a first dimension extending (e.g., a width) in a first direction D1, and a second dimension (e.g., a length) extending in a second direction D2 substantially perpendicular to the first direction D1. In the illustrated embodiment, the first dimension D1b of the base 104 is slightly greater than the first dimension D1w of the wrap 114, and the second dimension D2w of the wrap 114 is greater than the second dimension D2b of the base 104. The wrap 114 is positioned to substantially abut one peripheral edge 126 of the base panel 104 and to extend beyond (i.e., overlap) the opposite peripheral edge 128, such that a portion P of the wrap 114 is in a facing, substantially coextensive relationship with the base panel 104. In other examples, the portion P of the wrap 114 may be entirely coextensive with the base panel 104. In still other examples, the portion P of the wrap 114 may be in a facing relationship with only part of the base panel 104, and therefore, only partially coextensive with the base panel 104. In either case, susceptor 110 may be in a substantially superposed relationship with the portion P of susceptor 116 underlying the base panel 104.

The portion P of the wrap 114 underlying the base panel 104 may be referred to as a “fixed portion” in that the portion P has a determinate position with respect to the tray 102, even where the fixed portion is joined only partially to the tray 102. The remainder of the wrap 114 may be referred to as the “movable portion”, although some of the fixed portion also nay be capable of moving freely (i.e., independently from the tray 102).

To use the construct 100 according to one acceptable method illustrated schematically in FIGS. 1D and 1E, a food item F having at least an upper (or top) surface T and a lower (or bottom) surface B that are desirably heated, browned, and/or crisped is placed into the cavity 108 and seated on the interior side of the base panel 104 (i.e., on the food-contacting surface 112) such that the lower surface B of the food item is adjacent to (and in some cases, closely adjacent to) susceptor 110. The wrap 114 may be folded over the cavity 108 such that the susceptor 116 on the wrap 114 is brought into a superposed, facing relationship with the upper surface T of the food item F. If desired, the movable (i.e., unattached) end of the wrap 114 may then be tucked beneath the base panel 104 of the tray 102 to maintain the wrap 114 in an enwrapped state. In this configuration, the tucked end portion E of the wrap 114 is in a partially superposed, partially facing relationship with the portion P of the wrap 114 joined to the bottom of the tray 102, and is also in a partially superposed, partially facing relationship with part of the susceptor 110 on the tray 102.

Upon sufficient exposure to microwave energy, the susceptors 110, 116 convert at least a portion of the impinging microwave energy into thermal energy, which then can be transferred to the food item F to heat, brown, and/or crisp the surface of the food item F. Susceptor 116 may provide heat to the upper surface T and, in some cases, the sides of the food item F, while susceptor 110 and the portion of the susceptor 116 beneath the tray 102 provide heat to the lower surface B of the food item F. It will be appreciated that since there are two susceptors 110, 116 superposed with one another beneath the food item F, the bottom of the food item may be exposed to additional heat, which may further enhance heating, browning, and crisping of the lower surface B. Accordingly, in some instances the user may be instructed to flip the food item during the heating cycle if needed to ensure even heating of the upper and lower surfaces of the food item.

It will be appreciated that the dimensions of the microwave energy interactive wrap 114 may be adjusted to achieve various heating effects. For example, where the heat generated by the susceptors 110, 116 beneath the food item F is insufficient to provide the desired degree of heating, browning, and/or crisping, the tucked portion E of the wrap 114 may be dimensioned to extend substantially to the opposite peripheral edge 128 of the base panel 104, as shown schematically in FIG. 1F, such that there are three layers of susceptor (i.e., 110, 116, 116) beneath the food item. Further, in another embodiment (not shown), the second dimension (e.g., the length) of the wrap 114 may be even greater such that the cavity 108 is enwrapped a second time, such that at least two layers of susceptor overlie the cavity. Other numbers of layers are contemplated.

It also will be appreciated that the length of the wrap may be adjusted to accommodate the tray type, wall height, and particular food item being heated. In general, the length of the wrap may be at least two times the length of the base panel so that the wrap may underlie substantially the entire base panel and substantially overlie the food item seated on the base panel. And in many cases, additional length will be needed to provide sufficient excess wrap to form the tucked end portion and/or to account for the height of the food item(s) in the tray.

If the tray has no walls (such that the tray is just a panel), or if the tray has walls with a height less than or substantially equal to the height of the food item, the dimensions of the wrap as described above may be sufficient. However, where the tray includes side walls with a height greater than the food item, the length of the wrap may be at least two times the length of the base panel plus two times the height H of the pair of opposed side walls that will be enwrapped (FIG. 1A) plus any additional length needed to form the tucked end. In such an example, additional wrap length may be provided so the user can manually press the excess wrap into the cavity to bring the susceptor into closer proximity with the food item. As still another example, additional wrap may be provided where the food item is expected to expand, for example, as with some dough products, to accommodate the expansion of the rising and/or outwardly expanding dough.

It will also be understood that numerous other microwave energy interactive wraps may be used in accordance with the disclosure. For example, in some embodiments, the wrap may comprise a material that is capable of transforming from a substantially planar structure into a multidimensional structure to bring the susceptor into closer proximity with the surface of the food item. One type of such a material is a microwave energy interactive insulating material (“insulating material”), which generally may be any suitable material that both alters the effect of microwave energy on an adjacent food item to enhance heating, browning, and/or crisping, and that provides some degree of thermal insulation from the microwave heating environment.

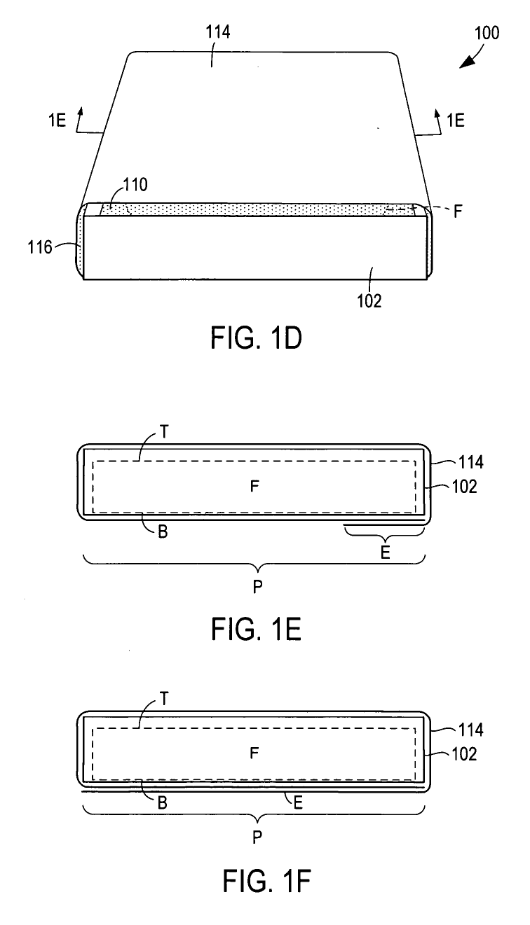

In some embodiments, the insulating material may include one or more susceptor layers in combination with one or more expandable insulating cells. For example, as illustrated schematically in cross-sectional view in FIG. 2A, one exemplary microwave energy interactive insulating material 200 includes a susceptor 202 supported on a first polymer film 204, collectively forming a susceptor film 206. The susceptor film 206 may be joined by lamination with an adhesive 208 or otherwise to a dimensionally stable substrate 210, for example, paper, such that layers 202, 204, 210 generally form a structure similar to the structure of FIG. 1B (in which the adhesive layer is not shown). The substrate 210 is joined to a second polymer film 212 in a patterned configuration using an adhesive 214 or any other suitable fastening material or technique, thereby forming a plurality of expandable insulating cells 216 (shown as voids) between the substrate 210 and the second polymer film 212. It will be noted that adhesives 208, 214 may differ from one another and/or adhesive 124 (FIG. 1C), or any of such adhesives 124, 208, 214 may be the same as one another.

The insulating material 200 may be cut and provided as a substantially flat, multi-layered sheet, as shown in FIG. 2B, which may be dimensioned to serve as a microwave energy interactive wrap in accordance with the disclosure.

While not wishing to be bound by theory, it is believed that as the susceptor 202 heats upon impingement by microwave energy, water vapor and other gases typically held in the substrate 210, for example, paper, and any air trapped in the closed cells 216 between the second polymer film 212 and the substrate 210, expand, thereby causing the susceptor film 206 and substrate 210 to bulge away from the second polymer film 212, as schematically illustrated in FIG. 2C. The resulting insulating material 200′ has a quilted or pillowed or lofted first surface 218 opposite a substantially flattened second surface 220. When microwave heating has ceased, the cells 216 typically deflate and return to a somewhat flattened state having a somewhat wrinkled appearance (not shown).

FIGS. 2D and 2E schematically illustrate the use of the insulating material 200 of FIGS. 2A-2C as a wrap 200 for the microwave energy interactive tray 102 of FIG. 1A to form another exemplary microwave heating construct, apparatus, or package 222. However, other shapes and types of panels, trays, and constructs may be used.

According to one acceptable method, the wrap 200 may be folded over the cavity 108 and optionally tucked beneath the tray 102 to maintain the wrap 200 in an enwrapped configuration with the susceptor film 206 facing the cavity 108, as shown schematically in FIG. 2D (in which the dashed lines of the wrap 200 schematically indicate the presence of the closed cells 216).

Upon sufficient exposure to microwave energy, the susceptor 110 on the tray 102 converts at least a portion of the impinging microwave energy into thermal energy, which then can be transferred to the adjacent surface of the food item F in the tray 102. As a result, the browning and/or crisping of the lower surface of the food item F may be enhanced.

At the same time, as the susceptor 202 in the wrap 200 heats and the expandable cells 216 inflate, the susceptor film 206 and the substrate 210 bulge towards the tray 102 (FIG. 2E). In the area overlying the cavity 108, the susceptor 202 may be urged towards the upper surface of the food item F to enhance browning and/or crisping. Notably, the pillowed surface of the wrap 200 may be able to conform more closely to the surface of the food item F, which may be particularly beneficial where the upper surface of the food item F is contoured and/or where multiple food items are used.

Depending on the degree of expansion and/or the length of the tucked end E, the expanded cells 216 beneath the tray 102 may elevate the tray 102 somewhat from the floor (or turntable) of the microwave oven. Such elevation may provide thermal insulation from the ambient heating environment of the microwave oven and may allow more heat to be transferred to the food item F. In some embodiments, the wrap 200 may be sized to provide two layers of insulating cells 216 beneath the tray 102 to provide further thermal insulation and/or elevation, as illustrated schematically in FIG. 2F. Additional benefits and aspects of such insulating materials are described in U.S. Pat. No. 7,019,271, U.S. Patent Application Publication No. 20060113300 A1, published Jun. 1, 2006, and U.S. Patent Application Publication No. 20080078759 A1, published Apr. 3, 2008, each of which is incorporated by reference herein in its entirety.

Numerous other microwave energy interactive structures may be used in accordance with the disclosure. Any of such structures may be used alone or in combination, and in any configuration, to form the tray and/or microwave energy interactive wrap. The structures may be joined partially or completely, or may remain separate from one another.

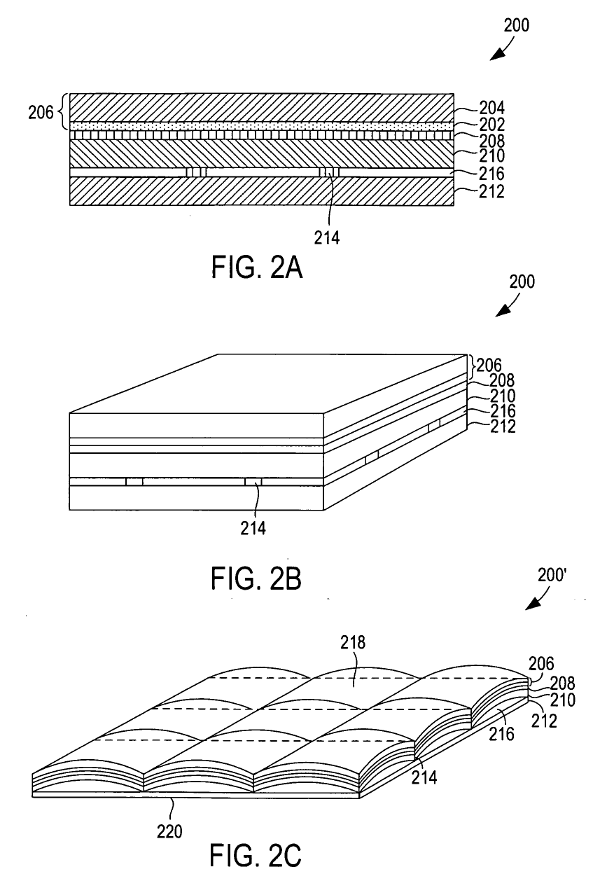

For example, FIG. 3 schematically illustrates another exemplary structure or insulating material 300. In this example, the structure 300 includes a polymer film layer 302, a susceptor layer 304, an adhesive layer 306, and a paper layer 308. Additionally, the structure 300 includes a second polymer film layer 310, an adhesive 312, and a paper layer 314. The layers may be adhered or affixed by a patterned adhesive 316 that defines a plurality of substantially closed, expandable cells 318.

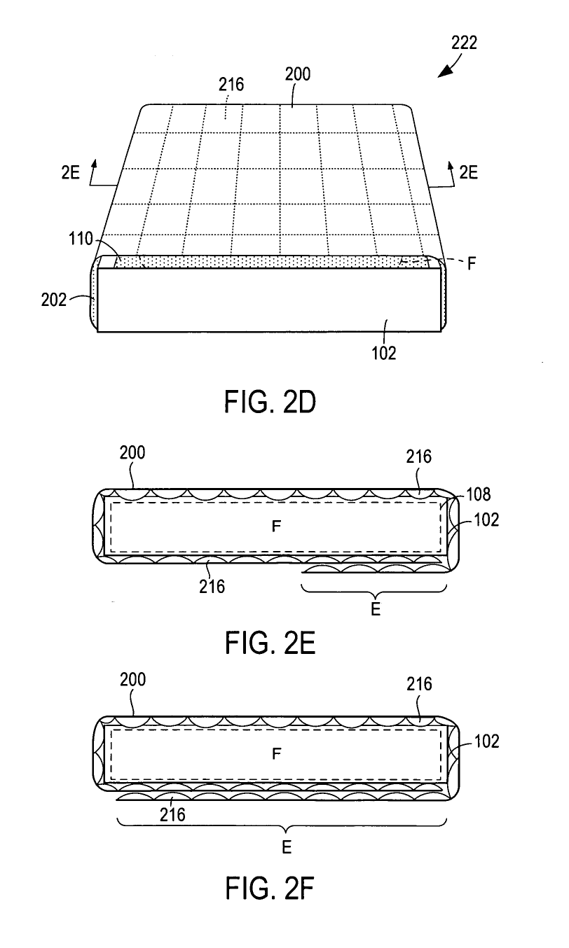

Likewise, FIG. 4 schematically illustrates yet another exemplary microwave energy interactive insulating material 400 that may be suitable for use as a wrap. In this example, the insulating material 400 includes a pair of adjoined, symmetrical layer arrangements. If desired, the two symmetrical arrangements may be formed by folding one layer arrangement onto itself.

The first symmetrical layer arrangement, beginning at the top of the drawing, comprises a polymer film layer 402, a susceptor layer 404, an adhesive layer 406, and a paper or paperboard layer 408. The adhesive layer 406 joins the polymer film 402 and the susceptor layer 404 to the paperboard layer 408. The second symmetrical layer arrangement, beginning at the bottom of the drawing, also comprises a polymer film layer 410, a susceptor layer 412, an adhesive layer 414, and a paper or paperboard layer 416. A patterned adhesive layer 418 is provided between the two paper layers 408, 416 to define a plurality of closed cells 420 that are adapted to inflate when sufficiently exposed to microwave energy. While not wishing to be bound by theory, it is believed that the additional susceptor layer results in greater heating and expansion of the insulating cells, thereby providing more thermal insulation as compared with an insulating material having a single susceptor layer.

It will be recognized that each of the exemplary insulating materials previously described include a moisture-containing layer (e.g. paper) that is believed to release at least a portion of the vapor that inflates the expandable cells. However, it is contemplated that insulating structures without such moisture-containing layers also may be used to form the package.

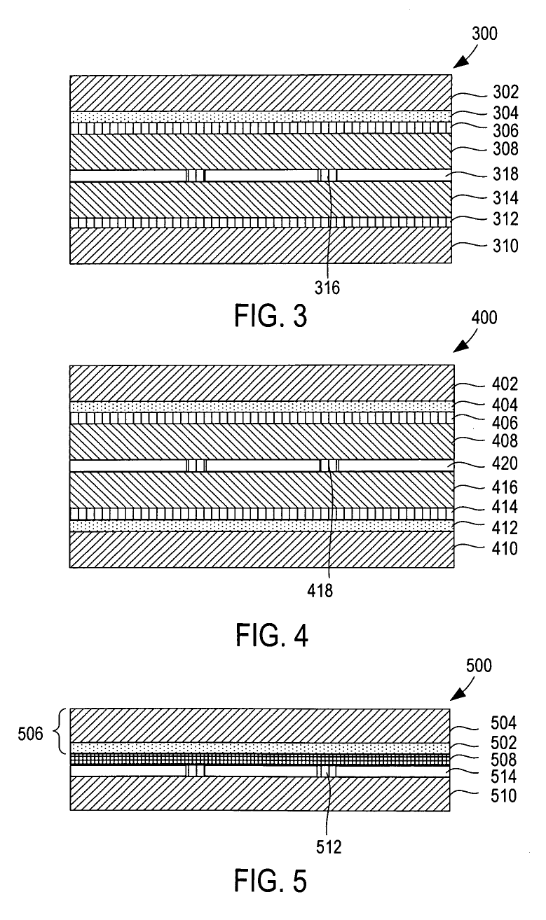

For example, FIG. 5 illustrates one example of an expandable cell insulating material 500 that inflates without the need for a moisture-containing layer, for example, paper. Instead, one or more reagents are used to generate a gas that inflates the cells.

As shown in FIG. 5, a thin layer of microwave interactive material 502 is supported on a first polymer film 504 to form a susceptor film 506. One or more reagents 508, optionally within a coating, lie adjacent at least a portion of the layer of microwave interactive material 502. The reagent 508 coated susceptor film 506 is joined to a second polymer film 510 using a patterned adhesive 512 or other material, or using thermal bonding, ultrasonic bonding, or any other suitable technique, such that closed cells 514 are formed in the material 500.

Numerous reagents may be suitable for use in the structure 500. For example, the reagents may comprise sodium bicarbonate (NaHCO₃) and a suitable acid. When exposed to heat, the reagents react to produce carbon dioxide. As another example, the reagent may comprise a blowing agent. Examples of blowing agents that may be suitable include, but are not limited to, p-p′-oxybis(benzenesulphonylhydrazide), azodicarbonamide, and p-toluenesulfonylsemicarbazide. However, it will be understood that numerous other reagents and released gases are contemplated hereby.

As the microwave interactive material 502 heats upon impingement by microwave energy, water vapor or other gases are released from (or generated by) the reagent 508, thereby exerting pressure on the susceptor film 508 on one side and the second polymer film 510 on the other side of the closed cells 514, as discussed in connection with the various other insulating materials described above. Even without a paper or paperboard layer, the gas resulting from the reagent is sufficient both to inflate the expandable cells and to absorb any excess heat from the susceptor. Such materials are described further in U.S. Patent Application Publication No. 20060278521 A1, which is incorporated by reference herein in its entirety.

Numerous other microwave heating constructs or packages are encompassed by the disclosure. Any of such constructs may be formed from various materials, provided that the materials are substantially resistant to softening, scorching, combusting, or degrading at typical microwave oven heating temperatures, for example, at from about 250° F. (about 121° C.) to about 425° F. (about 218° C.). The particular materials used may include microwave energy interactive materials, for example, those used to form susceptors (e.g., susceptors 116, 202, 304, 404, 502) and other microwave energy interactive elements, and microwave energy transparent or inactive materials, for example, those used to form the remainder of the package.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

While susceptors are illustrated herein, the construct also may include a foil or high optical density evaporated material having a thickness sufficient to reflect a substantial portion of impinging microwave energy. Such elements are typically formed from a conductive, reflective metal or metal alloy, for example, aluminum, copper, or stainless steel, in the form of a solid “patch” generally having a thickness of from about 0.000285 inches to about 0.05 inches (about 0.007239 mm to about 1.27 mm), for example, from about 0.0003 inches to about 0.03 inches (about 0.00762 mm to about 0.762 mm). Other such elements may have a thickness of from about 0.00035 inches to about 0.020 inches (about 0.00889 mm to about 0.508 mm), for example, about 0.016 inches (about 0.41 mm).

Larger microwave energy reflecting elements may be used where the food item is prone to scorching or drying out during heating. Smaller microwave energy reflecting elements may be used to diffuse or lessen the intensity of microwave energy. A plurality of smaller microwave energy reflecting elements also may be arranged to form a microwave energy directing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The breaks or apertures may extend through the entire structure, or only through one or more layers. The number, shape, size, and positioning of such breaks or apertures may vary for a particular application depending on the type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in one or more layers or materials used to form the construct, or may be a non-physical “aperture”. A non-physical aperture is a microwave energy transparent area that allows microwave energy to pass through the structure without an actual void or hole cut through the structure. Such areas may be formed by simply not applying a microwave energy interactive material to the particular area, or by removing microwave energy interactive material in the particular area, or by chemically and/or mechanically deactivating the microwave energy interactive material in the particular area. While both physical and non-physical apertures allow the food item to be heated directly by the microwave energy, a physical aperture also provides a venting function to allow steam or other vapors to escape from the interior of the construct.

The arrangement of microwave energy interactive and microwave energy transparent areas may be selected to provide various levels of heating, as needed or desired for a particular application. For example, where greater heating is desired, the total inactive (i.e., microwave energy transparent) area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance heating, browning, and/or crisping.

In some instances, it may be beneficial to create one or more discontinuities or inactive regions to prevent overheating or charring of the construct. Such areas may be formed by forming these areas of the construct without a microwave energy interactive material, by removing any microwave energy interactive material that has been applied, or by deactivating the microwave energy interactive material in these areas, as discussed above.

Further still, one or more panels, portions of panels, or portions of the construct may be designed to be microwave energy inactive to ensure that the microwave energy is focused efficiently on the areas to be heated, browned, and/or crisped, rather than being lost to portions of the food item not intended to be browned and/or crisped or to the heating environment. This may be achieved using any suitable technique, such as those described above.

As stated above, the microwave energy interactive element may be supported on a microwave inactive or transparent substrate (e.g., substrates 118, 302, 402, 504), for example, a polymer film or other suitable polymeric material, for ease of handling and/or to prevent contact between the microwave energy interactive material and the food item. The outermost surface of the polymer film may define at least a portion of the food-contacting surface of the package (e.g., surface 112). Examples of polymer films that may be suitable include, but are not limited to, polyolefins, polyesters, polyamides, polyimides, polysulfones, polyether ketones, cellophanes, or any combination thereof. In one particular example, the polymer film comprises polyethylene terephthalate. The thickness of the film generally may be from about 35 gauge to about 10 mil. In each of various examples, the thickness of the film may be from about 40 to about 80 gauge, from about 45 to about 50 gauge, about 48 gauge, or any other suitable thickness. Other non-conducting substrate materials such as paper and paper laminates, metal oxides, silicates, cellulosics, or any combination thereof, also may be used.

The microwave energy interactive material may be applied to the substrate in any suitable manner, and in some instances, the microwave energy interactive-material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating including circles, loops, hexagons, islands, squares, rectangles, octagons, and so forth.

Various materials may serve as the base material for the tray 102. For example, the tray may be formed at least partially from a polymer or polymeric material. As another example, all or a portion the construct may be formed from a paper or paperboard material. In one example, the paper has a basis weight of from about 15 to about 60 lbs/ream (lb/3000 sq. ft.) (about 24 g per square meter (gsm) to about 98 gsm), for example, from about 20 to about 40 lbs/ream (about 33 gsm to about 65 gsm). In another example, the paper has a basis weight of about 25 lbs/ream (about 27 gsm). In another example, the paperboard having a basis weight of from about 60 to about 330 lbs/ream (about 98 gsm to about 537 gsm), for example, from about 155 to about 265 lbs/ream (about 252 gsm to about 431 gsm). In one particular example, the paperboard has a basis weight of about 175 lbs/ream (about 285 gsm). The paperboard generally may have a thickness of from about 6 to about 30 mils (about 0.15 to about 0.76 mm), for example, from about 14 to about 24 mils (about 0.36 to about 0.61 mm). In one particular example, the paperboard has a thickness of about 16 mils (about 0.41 mm). Any suitable paperboard may be used, for example, a solid bleached or solid unbleached sulfate board, such as SUS® board, commercially available from Graphic Packaging International.

The package may be formed according to numerous processes known to those in the art, including using adhesive bonding, thermal bonding, ultrasonic bonding, mechanical stitching, or any other suitable process. Any of the various components used to form the package may be provided as a sheet of material, a roll of material, or a die cut material in the shape of the package to be formed (e.g., a blank).

It will be understood that with some combinations of elements and materials, the microwave energy interactive element may have a grey or silver color that is visually distinguishable from the substrate or the support. However, in some instances, it may be desirable to provide a package having a uniform color and/or appearance. Such a package may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave energy interactive element to the support, using a silver or grey toned support to mask the presence of the silver or grey toned microwave energy interactive element, using a dark toned substrate, for example, a black toned substrate, to conceal the presence of the silver or grey toned microwave energy interactive element, overprinting the metallized side of the polymer film with a silver or grey toned ink to obscure the color variation, printing the non-metallized side of the polymer film with a silver or grey ink or other concealing color in a suitable pattern or as a solid color layer to mask or conceal the presence of the microwave energy interactive element, or any other suitable technique or combination of techniques.

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A microwave heating apparatus for a food item, the microwave heating apparatus comprising:
a panel for receiving the food item, the panel including a first side for facing the food item and a second side opposite the first side;
a first susceptor joined to the first side of the panel; and
a microwave energy interactive wrap comprising a second susceptor, the microwave energy interactive wrap including
a first portion attached to the second side of the panel, the first portion being at least partially superposed with the first susceptor,
a second portion adapted to overlie the food item on the panel, and
a third portion adapted to be positioned beneath the first portion.

2. The microwave heating apparatus of claim 1, wherein the first portion, second portion, and third portion of the microwave energy interactive wrap each comprise the second susceptor.

3. The microwave heating apparatus of claim 1, wherein
the panel and the microwave energy interactive wrap each have a first dimension extending in a first direction and a second dimension extending in a second direction substantially perpendicular to the first direction,
the first dimension of the panel is greater than or equal to the first dimension of the microwave energy interactive wrap, and
the second dimension of the microwave energy interactive wrap is at least two times the second dimension of the panel.

4. The microwave heating apparatus of claim 1, wherein
the panel and the microwave energy interactive wrap each have a first dimension extending in a first direction and a second dimension extending in a second direction substantially perpendicular to the first direction,
the first dimension of the panel is greater than or equal to the first dimension of the microwave energy interactive wrap, and
the second dimension of the microwave energy interactive wrap is at least three times the second dimension of the panel.

5. The microwave heating apparatus of claim 1, wherein the first susceptor and the second susceptor each comprise a layer of microwave energy interactive material operative for converting at least a portion of impinging microwave energy into thermal energy.

6. The microwave heating apparatus of claim 1, wherein at least one of the first susceptor and the second susceptor comprises a layer of aluminum having an optical density of from about 0.21 to about 0.28.

7. The microwave heating apparatus of claim 1, wherein
the second susceptor is supported on a first polymer film,
a moisture-containing layer is joined to the second susceptor on a side of the second susceptor opposite the first polymer film, and
a second polymer film is joined to the moisture-containing layer in a patterned configuration, thereby defining a plurality of cells between the moisture-containing layer and the second polymer film.

8. The microwave heating apparatus of claim 7, wherein the cells are adapted to inflate upon sufficient exposure to microwave energy.

9. The microwave heating apparatus of claim 1, further comprising a plurality of walls extending upwardly from respective peripheral edges of the panel.

10. A microwave heating apparatus for a food item, the microwave heating apparatus comprising:
a tray including a base and a plurality of upstanding walls that define a cavity for receiving the food item, the base including a first side facing the cavity and a second side opposite the first side;
a susceptor joined to the first side of the base; and
a microwave energy interactive insulating material having a fixed portion joined to the second side of the base, and a movable portion adapted to overlie the food item in the cavity, the fixed portion and the movable portion of the microwave energy interactive insulating material including
a layer of microwave energy interactive material supported on a first polymer film,
a moisture-containing layer joined to the layer of microwave energy interactive material, and
a second polymer film joined to the moisture-containing layer in a patterned configuration, thereby defining a plurality of cells between the moisture-containing layer and the second polymer film, the cells being adapted to inflate upon sufficient exposure of the microwave energy interactive insulating material to microwave energy.

11. The microwave heating apparatus of claim 10, wherein the movable portion includes an end adapted to underlie the fixed portion beneath the tray.

12. The microwave heating apparatus of claim 10, wherein
the plurality of upstanding walls includes a pair of opposed walls, and
the movable portion is dimensioned to enwrap each wall of the pair of opposed walls.

13. The microwave heating apparatus of claim 12, wherein the movable portion is further dimensioned to underlie substantially all of the base.

14. A method of preparing a food item, comprising:
providing a food item having a bottom surface and a top surface and intended to be browned and/or crisped;
providing a microwave heating apparatus including
a dimensionally stable panel for receiving the food item,
a first susceptor joined to a first side of the panel, and
a microwave energy interactive wrap joined to a second side of the panel opposite the first side, the microwave energy interactive
wrap including a second susceptor;
positioning the food item on the first side of the panel such that the bottom surface of the food item is adjacent to the first susceptor; and
enwrapping the food item on the panel with the microwave energy interactive wrap, such that at least a portion of the second susceptor is adjacent to the top surface of the food item,
wherein the first susceptor and the second susceptor are adapted to convert at least a portion of impinging microwave energy into thermal energy, the thermal energy generated by the first susceptor being for at least partially browning and/or crisping the bottom surface of the food item, and the thermal energy generated by the second susceptor being for at least partially browning and/or crisping the top surface of the food item.

15. The method of claim 14, wherein at least a portion of the second susceptor on the second side of the panel is superposed with the first susceptor on the first side of the panel.

16. The method of claim 14, wherein enwrapping the food item on the panel with the microwave energy interactive wrap comprises covering the food item with the microwave energy interactive wrap and tucking an end of the microwave energy interactive wrap beneath the panel.

17. The method of claim 16, wherein tucking an end of the microwave energy interactive wrap beneath the panel comprises overlapping the end of the microwave energy interactive wrap with at least a portion of the microwave energy interactive wrap joined to the second side of the panel.

18. The method of claim 17, wherein the microwave energy interactive wrap is dimensioned so that the tucked end of the microwave energy interactive wrap overlaps with substantially all of the microwave energy interactive wrap joined to the second side of the panel.

19. The method of claim 14, wherein
the second susceptor is supported on a first polymer film,
the microwave energy interactive wrap further comprises
a moisture-containing layer joined to the second susceptor on a side of the second susceptor opposite the first polymer film, and
a second polymer film joined to the moisture-containing layer in a patterned configuration, thereby defining a plurality of cells between the moisture-containing layer and the second polymer film, and
exposing the enwrapped food item to microwave energy causes the cells to inflate, thereby urging the second susceptor towards the food item.

20. The method of claim 14, further comprising exposing the enwrapped food item to microwave energy, whereby the first susceptor and the second susceptor convert at least a portion of impinging microwave energy into thermal energy, the thermal energy generated by the first susceptor at least partially browns and/or crisps the bottom surface of the food item, and the thermal energy generated by the second susceptor being for at least partially browns and/or crisps the top surface of the food item.
